(19) United States
(12) Patent Application Publication
(10) Pub. No.: US 2011/0236147 A1
(43) Pub. Date: Sep. 29, 2011

(54) SURFACE MILLING CUTTER WITH CUTTING INSERTS, A TOOL FOR HOLDING A CUTTING INSERT WITH A CUTTING INSERT AND METHOD OF MACHINING A WORKPIECE WITH A SURFACE MILLING CUTTER HOLDING CUTTING INSERTS

(76) Inventor: Frank BODEWIG, Kerpen (DE)

(21) Appl. No.: 12/889,766

(22) Filed: Sep. 24, 2010

Related U.S. Application Data
(63) Continuation of application No. 12/016,442, filed on Jan. 18, 2008, now abandoned.
Application No. 12/016,442 is a continuation-in-part of application No. PCT/EP2006/006833, filed on Jul. 13, 2006.

(30) Foreign Application Priority Data
Jul. 20, 2005 (DE) 10 2005 033 920.4

(51) Int. Cl. B23C 5/16; B23C 5/20; B23C 3/13

(52) U.S. Cl. 409/132; 407/34; 407/42; 407/113

(57) ABSTRACT

A cutting insert, a tool for holding a cutting insert, with a cutting insert and method of machining a workpiece with a tool holding a cutting insert. The abstract of the disclosure is submitted herewith as required by 37 C.F.R. §1.72(b). As stated in 37 C.F.R. §1.72(b): A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims. Therefore, any statements made relating to the abstract are not intended to limit the claims in any manner and should not be interpreted as limiting the claims in any manner.

### CONTINUING APPLICATION DATA

This application is a continuation of U.S. application Ser. No. 12/016,442, filed on Jan. 18, 2008, which is a Continuation-In-Part application of International Patent Application No. PCT/EP2006/006833, filed on Jul. 13, 2006, which claims priority from Federal Republic of Germany Patent Application No. 10 2005 033 920.4, filed on Jul. 20, 2005. International Patent Application No. PCT/EP2006/006833 was pending as of the filing date of U.S. application Ser. No. 12/016,442. The United States was an elected state in International Patent Application No. PCT/EP2006/006833.

### BACKGROUND

1. Technical Field

The present application relates to a cutting insert, a tool for holding a cutting insert, with a cutting insert and method of machining a workpiece with a tool holding a cutting insert.

2. Background Information

By roughing or rough-machining, one understands in general a coarse machining and by finishing or finish-machining, in general a fine or subsequent machining of the rough surface generated by a preceding rough-machining operation.

One existing example of a finishing insert has a hexagonal base body whose edges are alternately designed as finishing lips and roughing lips. The roughing lips are called major lips and the finishing lips, minor lips. Several of the cutting inserts are provided for being arranged on a tool designed as a surface milling cutter, several roughing inserts for rough-machining being distributed along the front-face periphery of the surface milling cutter and finishing inserts for finish-machining being arranged at defined positions.

There is also another example of an existing cutting insert with an octagonal geometry, each of the eight lateral edges having one finishing lip and one roughing lip. For this purpose, the individual lips are arranged at different levels, i.e. they do not lie in the same plane. To each lip, a cutting face of an inclined design is adjacent radially to the center axis of the cutting insert, so that the surface topography of the cutting insert is very complex.

When machining a workpiece, such as with a surface milling cutter, there is the problem at higher feed speeds, that the machined surface has an insufficient surface quality with bumps in the shape of an arc of a circle.

### OBJECT OR OBJECTS

At least one object of the present application is to enable an improved surface quality in metal-cutting workpiece machining operations.

### SUMMARY

At least one possible embodiment of the present application teaches a cutting insert. In at least one possible embodiment of the present application, the cutting insert has an n-angled base body with six or more edges. The edges defining its n-angled base are alternately designed as finishing lips and as roughing lips, each lip being arranged in relation to the lips adjacent to it at different angles. Therefore, contrary to conventional cutting inserts, the base body has an irregular base. The conventional hexagonal or octagonal cutting inserts each have a regular base, so that the individual edges defining the base are arranged at identical angles relative to one another.

Due to the irregular design, i.e. the different angles between adjacent lips, the individual lips have different lengths. This measure provides that, in comparison with a regular design, several lips are displaced a little outwards, i.e. they are located at a greater distance from the longitudinal center axis of the cutting insert. Expediently, these lips in outward position, or located at a greater distance from the longitudinal center axis of the cutting insert, are the finishing lips. Through this measure, it is achieved that during the machining of the workpiece, the finishing lip engages the workpiece surface over a relatively large lip length, in addition to the leading roughing lip. As the finishing lip engages the workpiece surface over a relatively large length, an efficient finishing or fine machining is effected. The surface roughness with the periodically spaced rib-like bumps generated by the roughing lip at high feed rates of the tool is efficiently removed by the finishing lip, so that as a whole, a surface of a very high surface quality is obtained in only one operation, even at a high feed speed.

In view of designing the cutting insert in the simplest possible way, the n edges forming the lips are arranged in the same plane.

Adjacent lips of the cutting insert are arranged alternately at a large and a small angle relative to one another. Through the periodically recurrent pairs of angles, pairs of lips, each having a roughing and a finishing lip, are formed, all pairs of lips being of identical design. In this way, the cutting insert as a whole is symmetrical. A cutting insert with a hexagonal base body is, therefore, rotationally symmetrical relative to a rotation of 120° around the center axis. This symmetrical design offers the advantage that the cutting insert can also be mounted in existing tool carrying bodies for conventional, regular cutting inserts, without requiring great changes at the insert seat in the tool carrying body.

The large angle is in each case at least 5° larger than the nth part of the angular sum of the n-angled base body. In other words, each large angle is at least 5° larger than the angular sum of each pair of roughing lips 16A and finishing lips 16B. With a six-angled base body, the large angle is, therefore, at least 125°. When the angle increases, the finishing lip moves farther outwards, or at a greater distance from the longitudinal center axis of the cutting insert, so that an increasingly larger length of the finishing lip engages the workpiece surface during the machining operation of the workpiece.

The upper limit, or highest value, of the large angle is expediently a value of approximately 140°. This design still enables a sufficiently large lead angle of the roughing lip, expedient for the machining operation, relative to a machining plane defined by the workpiece surface. By lead angle, one generally understands in this case the angle at which the major or roughing lip is oriented relative to the machining plane, i.e. the workpiece surface.

To achieve the largest possible engagement of the finishing lip with the workpiece surface, it is provided, according to an expedient development, that the angular sum of the lead angle and the large angle amounts to approximately 180°. Through this measure, it is achieved that the finishing lip extends substantially, approximately parallel to the machining plane. Therefore, the large angle is determined as a function of the lead angle, through the above-mentioned relationship. In other words, the value of the large angle when added to the value of the lead angle will amount to approximately 180°. With a lead angle of 45°, the large angle is, therefore, 135°. As due to the symmetrical design, the large and the small angles amount to double the nth part of the angular sum of the n-angled base, this determines at the same time the value of the small angle. Therefore, with a six-angled basic geometry and a lead angle of 45°, the latter amounts to 105°.

To achieve a clean cutting with the finishing lip designed as the minor lip, the finishing lip possesses a slight minor-lip clearance relative to the machining plane. By minor-lip clearance, one understands here a spacing of the finishing lip from the machining plane, namely in the rear area of the finishing lip, which is spaced from the roughing lip designed as the major lip.

To form this minor-lip clearance, it is in principle possible to design the minor lip in a way inclined towards the machining plane at a slight angle of, for example 1° to 2°. In this case, the finishing lip would no longer be parallel to the machining plane and the angular sum of the lead angle and the large angle would be reduced by this angle and would be less than 180°.

For forming the minor-lip clearance, the finishing lip is designed as a so-called wiper lip. Expediently, it is provided in this case that the finishing lip is of a slightly rounded design and extended along a curvature. The latter is, in at least one embodiment example, a circular curve with a very large radius, such as in the range between 500 millimeters and 3000 millimeters. Through the design of the finishing lip as a curved lip, contrary to a lip extending in a straight line, the finishing lip has in the corner area next to the leading roughing lip a highest point, so that the finishing lip engages the workpiece surface in a defined manner. Due to the arc-shaped design of the finishing lip, the distance from the machining plane and, therefore, the minor-lip clearance increases increasingly in the further course of the finishing lip.

Expediently, the cutting insert is provided for a lead angle in one embodiment between 40° and 55°, and in another embodiment, such as for a lead angle of 45°. As the values of the large and small angles are determined as a function of the lead angle, a special cutting insert is provided for each lead angle. The cutting insert, based on a hexagonal basic geometry, possesses a six-angled basic geometry.

To enable the longest possible tool life of the cutting insert, the latter is designed as a double-sided indexable insert with 2n lips, i.e. lips are formed both on its top side and on its bottom side. As due to the chosen special design, a pair of lips having a roughing lip and a finishing lip engage the workpiece in each case during a machining operation, the cutting insert can be indexed only n/2 times per side. Therefore, with a six-angled basic geometry, the cutting insert can be indexed 3 times per side and altogether 6 times, until it is completely worn.

The task is solved according to the application by a tool with the features in which the tool carrying body 4 has an insert seat 10 with at least two front-face bearing faces 19, a holding pocket 22 forming a clearance being provided between the bearing faces 19. The task is, furthermore, solved by a method for machining a workpiece with the help of a tool 2 comprising at least one cutting insert 8, one of the roughing lips 16A being oriented to a machining plane 14 of the workpiece at a defined lead angle κ and engaging the workpiece during a feed motion of the tool, the finishing lip 16B adjacent to the roughing lip 16A simultaneously engaging the workpiece. The advantages in at least one possible embodiment of the present application of the cutting insert can analogously be applied to the tool and to the method, too.

In at least one possible embodiment of the present application, the tool comprises a tool carrying body having an insert seat having at least two front-face bearing faces on which two of the front-face sides of the cutting insert planely abut in mounted position. Between the bearing faces, a holding pocket forming a clearance is provided. The insert seat can be designed directly in the tool carrying body or in an exchangeable cassette. In mounted position, one cutting corner of the cutting insert protrudes into the clearance, without abutting on the insert seat in this area. Due to this measure, the tool carrying body is also suitable for receiving conventional cutting inserts with equal-sided n-angled, for example hexagonal, geometry and can, therefore, optionally be fitted with conventional cutting inserts or with the cutting inserts described here. The two bearing faces are for this purpose oriented along the sides of an equal-sided n-angled surface, in which each two adjacent edges include the same angle between them. Therefore, with a hexagonal basic geometry, the two bearing faces (the imaginary extensions of the bearing faces into the holding pockets) include an angle of 60°, so that the front-face sides of a conventional hexagonal cutting insert also planely abut on the bearing faces.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

Possible embodiment examples of the present application are explained in detail in the following by means of the drawings, in which, partly in schematic representations:

FIG. 1 is a perspective view of a tool designed as a surface milling cutter,

FIG. 2 is a sectional view of the surface milling cutter according to FIG. 1,

FIG. 2A is a sectional view of the surface milling cutter engaging a workpiece surface;

FIG. 3 is an enlarged, simplified detail view of a cutting insert in its mounting position in an insert seat of a tool carrying body,

FIG. 4 is a simplified view of an insert designed for a lead angle of 40°,

FIG. 5 is a simplified view of an insert designed for a lead angle of 55°,

FIG. 6 is a simplified perspective view of a cutting insert,

FIG. 6A is a simplified perspective view of a cutting insert, showing more detail with respect to the edges which lie in the same plane as the bottom side.

FIG. 7 is a front-face view of a cutting insert, and

FIG. 8 is an enlarged view of the detail marked with a circle in FIG. 2 in the area of the rounded transition from a roughing lip to a finishing lip.

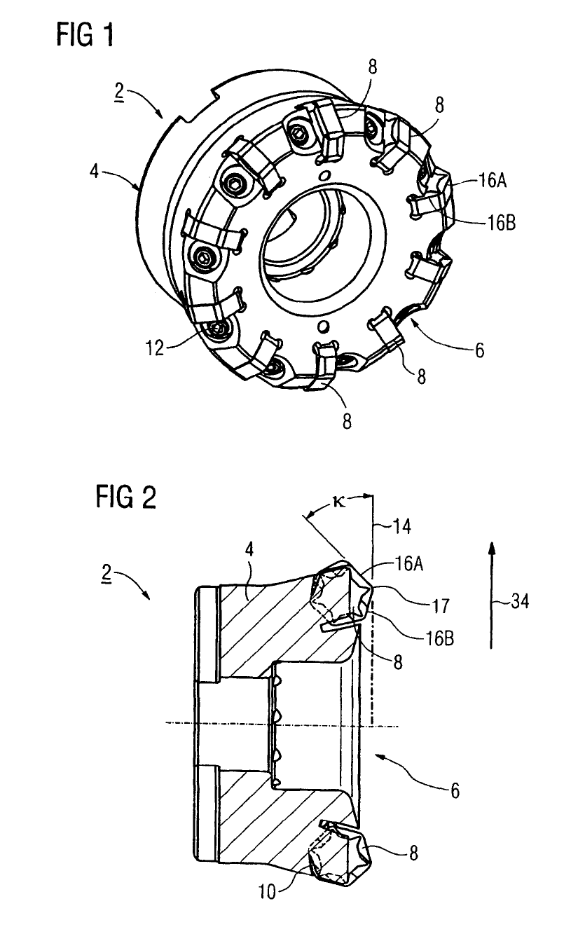

### DESCRIPTION OF EMBODIMENT OR EMBODIMENTS

In the figures, parts having the same function are generally marked with the same reference numbers.

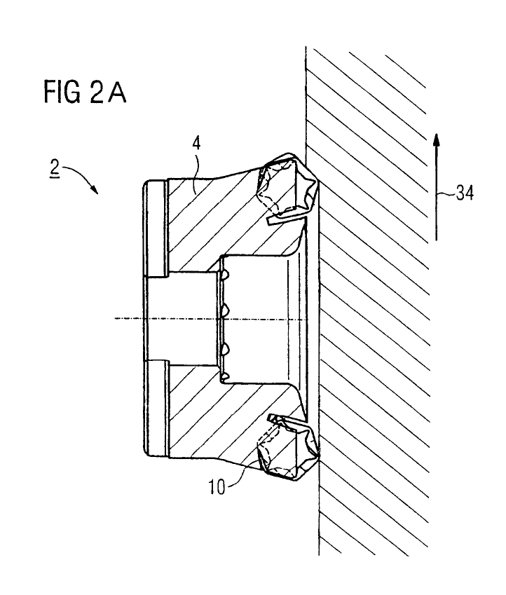

The tool designed in one embodiment example as a surface milling cutter 2 comprises a tool carrying body 4 having a front-face machining side 6. A number of cutting inserts 8 are arranged on, and distributed over, the periphery of the machining side 6. Each of the cutting inserts 8 lies in an insert seat 10 formed directly into the tool carrying body 4 (as seen in FIGS. 2 and 3). Alternatively to this, it is possible to arrange the cutting inserts 8 in cassettes which, in turn, are held in the tool carrying body 4. The cutting inserts 8 are held in a defined position in the tool carrying body 4 by means of screws 12.

To machine a workpiece surface, the machining side 6 of the surface milling cutter is brought into engagement with the workpiece surface, the workpiece surface defining a machining plane 14, which can be seen in FIG. 2. The machining plane is defined by the individual cutting inserts 8 of the surface milling cutter 2. FIG. 2A shows the surface milling cutter 2, as seen in FIG. 2, engaging the workpiece surface.

The lips 16A and 16B are designed as major and minor lips and merge into each other via a rounded cutting corner 17. The cutting insert 8 is designed as a double-sided indexable insert whose edges are designed as lips 16A and 16B. One of the lips, namely a roughing lip 16A, is arranged relative to the machining plane 14 at a lead angle κ (kappa), which in at least one possible embodiment of the present application is 45°.

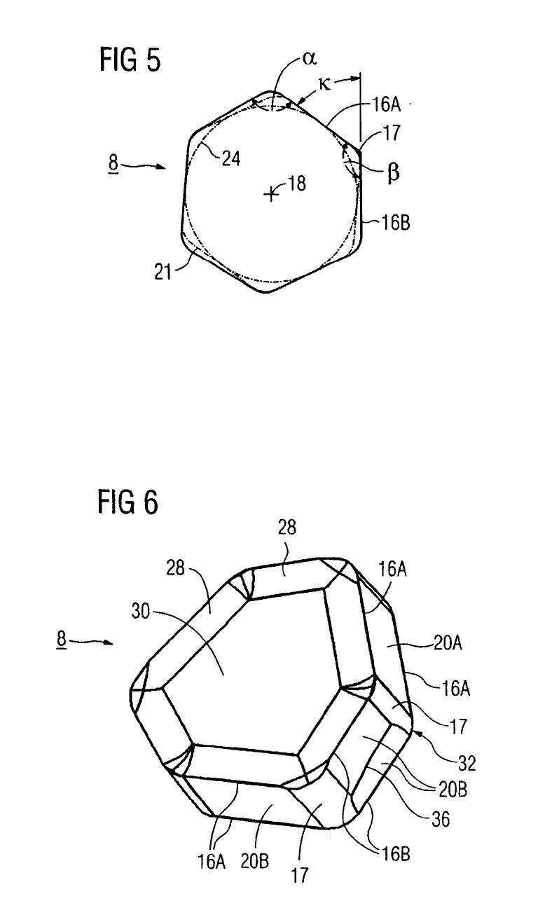

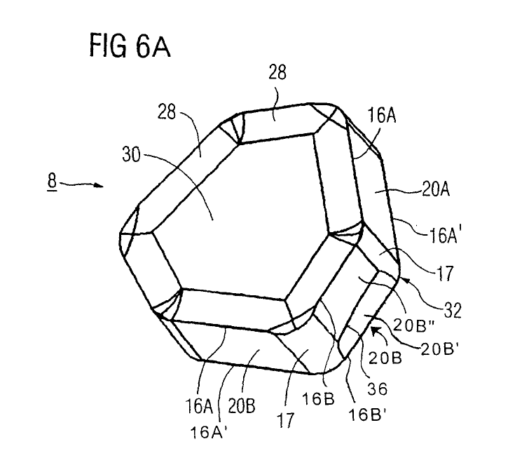

The basic geometry of the cutting insert 8, i.e. its cross-sectional area oriented perpendicularly to its center axis 18, as well as its mounting position in the insert seat 10 will be explained by means of FIG. 3. In at least one possible embodiment example, the cutting insert 8 possesses a six-angled basic geometry, based on a regular hexagonal cross-section geometry. The insert seat 10 has two bearing faces 19, on which two front-face sides 20A and 20B (as seen in FIG. 6) of the cutting insert 8 abut. The bearing faces 19 include an angle of 60°, whereby the insert seat 10 is also designed for receiving a conventional hexagonal cutting insert of regular hexagonal shape. The cross-section geometry of such a conventional cutting insert is indicated in FIG. 3 by a dash-dotted line forming a hexagon 21. The insert seat 10 has on its rear side a holding pocket 22, into which a partial area of the cutting insert 8 protrudes.

Contrary to the hexagonal cross-sectional area, the cutting insert 8 is of an irregular design, in that the edges of the cutting insert 8 forming the individual lips 16A and 16B are arranged alternately at a small angle α and a large angle β relative to one another. In FIG. 3, the lead angle κ is 45°, each small angle α is 105° and each large angle β is 135°. Due to the irregular design, alternately a long lip 16A and a shorter lip 16B are formed in pairs, the longer lip 16A being designed as a roughing lip and the shorter lip 16B, as a finishing lip in the manner of a wiper lip.

As is directly recognizable through a comparison with the hexagonal geometry represented in dash-dotted lines, the finishing lip 16B is displaced a little outwards from the center axis 18 towards the machining plane 14, due to the irregular design. In at least one embodiment example, the angles α, β as well as the lead angle κ are chosen such that the finishing lip 16B extends substantially parallel to the machining plane 14.

Furthermore, an incircle 24 is disposed within the cutting insert in FIG. 3 in dash-dotted lines. The individual sides of the hexagon 21, also drawn in dash-dotted lines, form tangents of this incircle. The bearing faces 19 also form tangents of the incircle 24. The cutting insert 8 in its irregular design is designed in such a way that alternately every second edge, i.e. in each case the roughing lip 16A, also touches the incircle 24 tangentially. This design guarantees that the cutting insert 8 having the irregular geometry can also be used in insert seats 10 for conventional hexagonal cutting inserts. Only the holding pocket 22 at the bottom of the insert seat is needed for receiving the finishing lip 16B. In other words, the only variation on the shape of the insert seat necessary to accommodate the protruding finishing lip, is the holding pocket 22.

FIG. 3 also indicates in a schematic and greatly simplified manner, adjacent to the individual lips 16A, 16B, chip breakers 28, which in at least one possible embodiment of the present application are formed in the manner of indentations extending in a straight line. The chip breakers 28 serve for a specific and defined treatment of the chip removed by the lips 16A, 16B, i.e. for a specific chip guidance, chip forming and also for a specific breaking of the chip. The chip breakers can also be designed with other geometries.

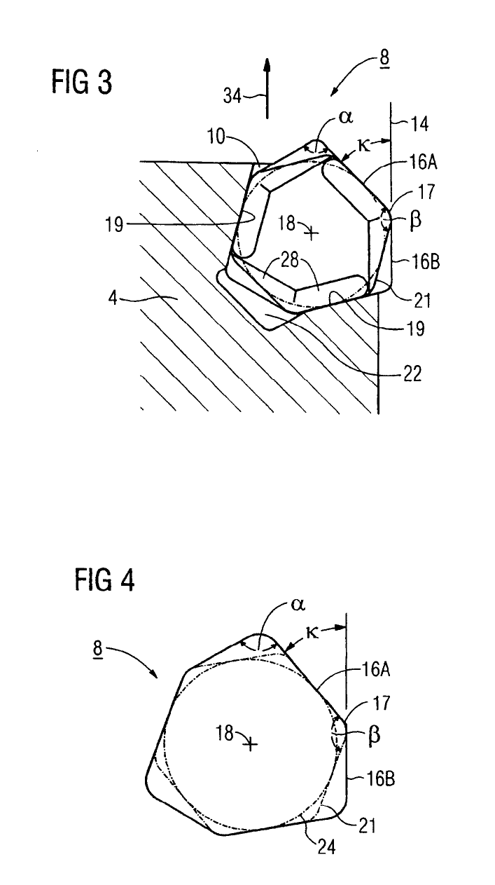

FIGS. 4 and 5 show cutting inserts 8 designed for a lead angle κ of 40° (FIG. 4) and for a lead angle κ of 55° (FIG. 5).

For the cutting insert 8 according to FIG. 4 and the lead angle κ of 40°, the large angle β is 140° and the small angle α, 100°.

For the cutting insert 8 according to FIG. 5, designed for a lead angle κ of 55°, on the other hand, the large angle β is 125° and the small angle α, 115°. The angular sum of these two angles is in each case 240°, i.e. double the value of the angle of 120° between two adjacent sides of a regular hexagon 21.

By means of the perspective view of the cutting insert 8 according to FIGS. 6 and 6A, one recognizes that the lips 16A and 16B lie in the same plane. The cutting insert 8 has a top side 30 and a bottom side 32 opposite this top side 30, and in plane-parallel orientation to it. As shown in FIG. 6A, the edges of the top side 30 are designed as lips 16A and 16B and the edges of the bottom side 32 are designed as lips 16A′ and 16B′. Opposite lips 16A and 16B of the top side 30 and opposite lips 16A′ and 16B′ of the bottom side 32 are connected with one another through the front face 20A and 20B of the cutting insert 8. Opposite lips 16A and 16B lie in the same plane, which is arranged at right angles to the planes defined by the top side 30 and the bottom side 32. Opposite lips 16A′ and 16B′ lie in the same plane, which is arranged at right angles to the planes defined by the top side 30 and the bottom side 32. The front face connecting the two opposite roughing lips 16A and 16A′ with one another is marked with the reference number 20A and the front face connecting the two opposite finishing lips 16B and 16B′ with one another is marked with the reference number 20B.

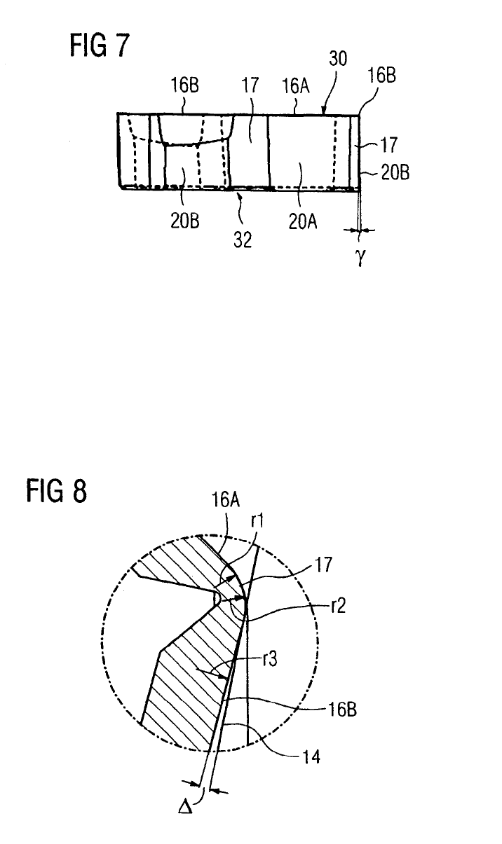

In at least one possible embodiment of the present application, according to FIG. 6A, in which the cutting insert 8 is designed as a double-sided indexable insert, the front face 20B connecting the finishing lips 16B and 16B′ opposite one another, has two partial front faces, 20B′ and 20B″, which meet at a center line, 36. These two partial front faces are arranged with an inward inclination towards each other at an angle γ (gamma), (as seen in FIG. 7). This inclined arrangement can be seen in the representation according to FIG. 7, which shows a side view of the front faces 20A and 20B of a cutting insert 8 designed as an only one-sided indexable insert. The front face 20B, which is here of a one-piece design, is inclined towards the top side 30, as compared with the perpendicular, at the angle γ. The angle γ is in at least one embodiment example 2° and lies in an embodiment in the range between 0.5° and 5°. The angle γ as a whole is designed in the manner of a clearance angle and the front face 20B forms a flank towards the finishing lip 16B. In the double-sided indexable insert according to FIG. 6, the two partial front faces are, therefore, starting from opposite finishing lips 16B and 16B′ arranged in each case with an inward inclination towards each other at the angle γ and meet on a common center line 36.

To achieve the best possible cutting result, the finishing lip 16B is designed as a wiper lip. The enlarged view of the detail in the area of the rounded cutting corner 17, marked with a circle in FIG. 2, one can see that the rounded transition from the roughing lip 16A to the finishing lip 16B is composed of several radii r1, r2, the radius r1 oriented towards the roughing lip 16A having a smaller value than the radius r2 oriented towards the finishing lip 16B. Through this measure, a better surface quality of the machined workpiece is achieved.

FIG. 8 also shows that another, very large radius r3 is adjacent to the second radius r2. The circular curve or curvature defined by the large radius r3 defines the course of the finishing lip 16B. That means that the finishing lip 16B as a whole is designed with a curved or arc-shaped course. Depending on the application, the radius r3 lies in a range between 500 millimeters and 3000 millimeters. Due to the very large diameter, the finishing lip 16B appears as a straight line, even in the enlarged representation according to FIG. 8. Due to the rounded design, the highest point of the finishing lip 16B, relative to the machining plane 14, is adjacent to the cutting corner 17. With increasing distance from the cutting corner 17, the finishing lip 16B increasingly moves away from the machining plane 14, so that a minor-lip clearance Δ is formed. Therefore, the minor-lip clearance Δ defines a distance between the finishing lip 16B and the machining plane 14. In at least one possible embodiment of the present application, the minor-lip clearance Δ is exclusively formed by the curved course of the finishing lip 16B.

In the figures, the cutting insert 8 was described in connection with the surface milling cutter 2 as the tool and with a six-angled base. In principle, such a cutting insert is also possible for other tool types and also with other basic geometries, for example an 8, 10 or 12-angled base.

When machining the surface of a workpiece, the surface milling cutter 2 rotates on the one hand about its longitudinal and rotational axis. In the representation according to FIG. 3, the rotational axis lies in the plane of the paper in a horizontal, i.e. perpendicular to the machining plane 14. At the same time, the surface milling cutter 2 is traversed in the feed direction 34 indicated by an arrow 34 (as seen in FIG. 2 and FIG. 3), parallel to the machining plane 14. Through this movement, the roughing lip 16A continually removes material from the top side of the workpiece. The workpiece surface rough-machined by the roughing lip 16A is then finish-machined by the adjacent finishing lip 16B of the same cutting insert 8, said finishing lip 16B being, in at least one embodiment example, effective over its entire length through its orientation parallel to the machining plane 14. In this way, a very efficient finish-machining is achieved and a very high surface quality of the machined workpiece is achieved.

One feature or aspect of an embodiment is believed at the time of the filing of this patent application to possibly reside broadly in a cutting insert 8 for machining a workpiece with an n-angled base body with n≧6, whose n edges defining the n-angled base are alternately designed as finishing lips 16B for finish-machining and as roughing lips 16A for rough-machining of the workpiece, characterized in that each lip 16A and 16B is arranged relative to its adjacent lips 16B and 16A at different angles α, and β, so that the lips 16B and 16A are alternately of different lengths, adjacent lips 16A and 16B are arranged alternately at a large angle β and a small angle α relative to one another and the large angle β being maximally 140°.

The present application relates to a cutting insert, a tool, and a method of machining a workpiece, the cutting insert having an n-angled and n-sided base body with n≧6, the n edges defining the n angled base of said base body being alternately designed as finishing lips for finish-machining and as roughing lips for rough-machining of the workpiece.

Another feature or aspect of an embodiment is believed at the time of the filing of this patent application to possibly reside broadly in a surface milling cutter having a central rotational axis, said surface milling cutter comprising: a tool carrying body with a front milling face at one end; a plurality of surface milling cutter cutting inserts disposed about the periphery of said front milling face; said surface milling cutter cutting inserts being disposed to rotate in a planar configuration substantially at a right angle to the rotational axis; said surface milling cutter cutting inserts comprising n-angled and n-sided base bodies where n is equal to six; each said n-sided surface milling cutter cutting insert comprising n-edges disposed at apex angles, which apex angles are measured through the material of said insert, said apex angles being less than 180 degrees and greater than 90 degrees; said inserts each comprising: three roughing lips; said three roughing lips comprising a first roughing lip; said first roughing lip being disposed at a substantial lead angle, to the rotational axis which said first roughing lip is disposed to take a substantial deep cut in a workpiece, in operation; said lead angle of said first roughing lip being less than 90 degrees; three finishing lips; said three finishing lips comprising a first finishing lip; said first finishing lip being disposed substantially parallel to a surface of a deep cut made by said first roughing lip; said first finishing lip being configured to finish, during operation, a surface of a workpiece by smoothing the surface of the deep cut made by said first roughing lip; each of said three finishing lips being disposed immediately after its corresponding roughing lip, in operation, to finish and smooth the deep rough cut made by each of said three roughing lips; said first roughing lip having a first end and a second end; said first finishing lip having a first end and a second end; said second end of said first roughing lip and said first end of said first finishing lip being disposed adjacent one another; said first roughing lip and said first finishing lip forming a first pair of lips in operation; said first roughing lip being configured and disposed to lead said first finishing lip, in operation, such that, said first roughing lip machines away a deep, rough, cut; said first finishing lip, being configured and disposed to immediately follow, in operation, said first roughing lip to finish and smooth a deep rough cut made by said first roughing lip during operation; said first roughing lip and said first finishing lip forming a first apex angle therebetween; said first roughing lip having a first length and said first finishing lip having a length different from said first length; a second finishing lip having a first end and a second end; said second end of said second finishing lip being disposed adjacent said first end of said first roughing lip; said first roughing lip and said second finishing lip being disposed at a second apex angle; said second apex angle being different from said first apex angle; said three roughing lips comprising a second roughing lip; said three finishing lips comprising a second finishing lip; said second roughing lips and said second finishing lip being disposed immediately adjacent one another; said second roughing lip having a first end and a second end; said second finishing lip having a first end and a second end; said second end of said second roughing lip and said first end of said second finishing lip being disposed adjacent one another; said second roughing lip and said second finishing lip forming a second pair of lips, in operation, upon said second pair of lips being positioned in said front milling face for cutting; said second roughing lip being configured to be disposed to lead said second finishing lip, in operation, such that, said second roughing lip machines away a deep, rough, cut upon said second pair of lips being positioned in said front milling face for cutting; said second finishing lip, being configured to immediately follow, upon said second pair of lips being positioned in said front milling face for cutting, said second roughing lip to finish and smooth a deep rough cut made by said second roughing lip during operation; said second roughing lip and said second finishing lip forming a third apex angle therebetween; said second roughing lip having a second length and said second finishing lip having a length different from said second length; said three finishing lips comprising a third finishing lip; said third finishing lip having a first end and a second end; said second end of said third finishing lip being disposed adjacent said first end of said second roughing lip; said second roughing lip and said third finishing lip being disposed at a fourth apex angle; said fourth apex angle being different from said third apex angle; said three roughing lips comprising a third roughing lip; said third roughing lip and said third finishing lip being disposed immediately adjacent one another; said third roughing lip having a first end and a second end; said third finishing lip having a first end and a second end; said second end of said third roughing lip and said first end of said third finishing lip being disposed adjacent one another; said third roughing lip and said third finishing lip forming a third pair of lips upon said third pair of lips being positioned in said front milling face for cutting; said third roughing lip being configured to be disposed to lead said third finishing lip, in operation, such that, said third roughing lip machines away a deep, rough, cut; said third finishing lip being configured to immediately follow, in operation, said third roughing lip to finish and smooth a deep rough cut made by said third roughing lip during operation; said third roughing lip and said third finishing lip forming a fifth apex angle therebetween; said third roughing lip having a third length and said third finishing lip having a length different from said third length; said first, second, and third roughing lips having a same length; said first, second and third finishing lips having a same length; said first, second and third roughing lips having a length different from said first, second and third finishing lips; said third finishing lip having a first end and a second end; said second end of said first finishing lip being disposed adjacent said first end of said third roughing lip; said first end of said third roughing lip being disposed adjacent said second end of said first finishing lip; said third roughing lip and said first finishing lip forming a sixth apex angle; said sixth apex angle being different from said fifth apex angle; said first apex angle, said third apex angle and said fifth apex angle being equal, and greater than said second apex angle, said fourth apex angle, and said sixth apex angle; and said second apex angle, said fourth apex angle, and said sixth apex angle being equal.

The components disclosed in the various publications, disclosed or incorporated by reference herein, may possibly be used in possible embodiments of the present invention, as well as equivalents thereof.

Yet another feature or aspect of an embodiment is believed at the time of the filing of this patent application to possibly reside broadly in the cutting insert 8 characterized in that the n edges lie in one plane.

The purpose of the statements about the technical field is generally to enable the Patent and Trademark Office and the public to determine quickly, from a cursory inspection, the nature of this patent application. The description of the technical field is believed, at the time of the filing of this patent application, to adequately describe the technical field of this patent application. However, the description of the technical field may not be completely applicable to the claims as originally filed in this patent application, as amended during prosecution of this patent application, and as ultimately allowed in any patent issuing from this patent application. Therefore, any statements made relating to the technical field are not intended to limit the claims in any manner and should not be interpreted as limiting the claims in any manner.

Still another feature or aspect of an embodiment is believed at the time of the filing of this patent application to possibly reside broadly in the surface milling cutter, wherein each of said first apex angle, said third apex angle, and said fifth apex angle is at least 5° larger than the nth part of the angular sum of the n-angled base body.

A further feature or aspect of an embodiment is believed at the time of the filing of this patent application to possibly reside broadly in the cutting insert 8 characterized in that the large angle β is at least 5° larger than the nth part of the angular sum of the n-angled base body.

The appended drawings in their entirety, including all dimensions, proportions and/or shapes in at least one embodiment of the invention, are accurate and are hereby included by reference into this specification.

Still another feature or aspect of an embodiment is believed at the time of the filing of this patent application to possibly reside broadly in the cutting insert 8 characterized in that the roughing lip 16A is arranged in a mounting position in a tool carrying body 4 in an orientation at a defined lead angle κ to a machining plane 14, the angular sum of the lead angle κ and of the large angle β being approximately 180°.

The background information is believed, at the time of the filing of this patent application, to adequately provide background information for this patent application. However, the background information may not be completely applicable to the claims as originally filed in this patent application, as amended during prosecution of this patent application, and as ultimately allowed in any patent issuing from this patent application. Therefore, any statements made relating to the background information are not intended to limit the claims in any manner and should not be interpreted as limiting the claims in any manner.

A further feature or aspect of an embodiment is believed at the time of the filing of this patent application to possibly reside broadly in the cutting insert 8 characterized in that the finishing lip 16B has a minor-lip clearance Δ to the machining plane 14.

All, or substantially all, of the components and methods of the various embodiments may be used with at least one embodiment or all of the embodiments, if more than one embodiment is described herein.

Another feature or aspect of an embodiment is believed at the time of the filing of this patent application to possibly reside broadly in the cutting insert 8 characterized in that the finishing lip 16B is designed as a wiper lip.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

Yet another feature or aspect of an embodiment is believed at the time of the filing of this patent application to possibly reside broadly in the cutting insert 8 characterized in that the finishing lip 16B extends along a curvature.

All of the patents, patent applications and publications recited herein, and in the Declaration attached hereto, are hereby incorporated by reference as if set forth in their entirety herein.

Still another feature or aspect of an embodiment is believed at the time of the filing of this patent application to possibly reside broadly in the surface milling cutter, wherein the angular sum of the lead angle and of said first apex angle being approximately 180°.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

A further feature or aspect of an embodiment is believed at the time of the filing of this patent application to possibly reside broadly in the cutting insert 8 characterized in that the curvature is a circular curve with a radius r3, which lies in the range between 500 millimeters and 3000 millimeters.

Another feature or aspect of an embodiment is believed at the time of the filing of this patent application to possibly reside broadly in the cutting insert 8 characterized in that it is provided for lead angles κ between 40° and 55°, in one embodiment example for a lead angle κ of 45°.

Still another feature or aspect of an embodiment is believed at the time of the filing of this patent application to possibly reside broadly in the cutting insert 8 characterized in that it is designed as a double-sided indexable insert with 2n lips 16A and 16B.

Yet another feature or aspect of an embodiment is believed at the time of the filing of this patent application to possibly reside broadly in the cutting insert 8 characterized in that opposing lips 16A and 16B are connected in each case over a front face 20A and 20B having two partial front faces arranged at a clearance angle γ and inwardly inclined towards one another.

It will be understood that any or all of the examples of patents, published patent applications, and other documents which are included in this application and including those which are referred to in paragraphs which state “Some examples of . . . which may possibly be used in at least one possible embodiment of the present application . . . ” may possibly not be used or useable in any one or more or any embodiments of the application.

The sentence immediately above relates to patents, published patent applications and other documents either incorporated by reference or not incorporated by reference

Another feature or aspect of an embodiment is believed at the time of the filing of this patent application to possibly reside broadly in a tool 2 for machining a workpiece, such as a milling cutter, with a tool carrying body 4, on which at least one cutting insert 8 is secured.

Yet another feature or aspect of an embodiment is believed at the time of the filing of this patent application to possibly reside broadly in a tool 2 in which the tool carrying body 4 has an insert seat 10 with at least two front-face bearing faces 19, a holding pocket 22 forming a clearance being provided between the bearing faces 19.

Still another feature or aspect of an embodiment is believed at the time of the filing of this patent application to possibly reside broadly in a method for machining a workpiece with the help of a tool 2 comprising at least one cutting insert 8, one of the roughing lips 16A being oriented to a machining plane 14 of the workpiece at a defined lead angle κ and engaging the workpiece during a feed motion of the tool, the finishing lip 16B adjacent to the roughing lip 16A simultaneously engaging the workpiece.

Some examples of cutting inserts that may possibly be utilized or adapted for use in at least one possible embodiment may possibly be found in the following patent applications: WO 97/27967; and U.S. Pat. No. 6,604,893.

A further feature or aspect of an embodiment is believed at the time of the filing of this patent application to possibly reside broadly in the surface milling cutter, wherein said first finishing lip has a minor-lip clearance to the securing plane.

All of the patents, patent applications or patent publications, which were cited in the International Search Report dated Oct. 13, 2006, and/or cited elsewhere are hereby incorporated by reference as if set forth in their entirety herein as follows: WO 2004 080633 A1, EP 0 342 689 A2, EP 1 108 489 A2, and U.S. Pat. No. 6,604,893 B2.

Another feature or aspect of an embodiment is believed at the time of the filing of this patent application to possibly reside broadly in the surface milling cutter, wherein each of said three finishing lips is designed as a wiper lip.

The corresponding foreign and international patent publication applications, namely, Federal Republic of Germany Patent Application No. 10 2005 033 920.4, filed on Jul. 20, 2005, having inventor Frank BODEWIG, and DE-OS 10 2005 033 920.4 and DE-PS 10 2005 033 920.4, and International Application No. PCT/EP2006/006833, filed on Jul. 13, 2006, having WIPO Publication No. WO2007/009650 and inventor Frank BODEWIG, are hereby incorporated by reference as if set forth in their entirety herein for the purpose of correcting and explaining any possible misinterpretations of the English translation thereof. In addition, the published equivalents of the above corresponding foreign and international patent publication applications, and other equivalents or corresponding applications, if any, in corresponding cases in the Federal Republic of Germany and elsewhere, and the references and documents cited in any of the documents cited herein, such as the patents, patent applications and publications, are hereby incorporated by reference as if set forth in their entirety herein.

Still another feature or aspect of an embodiment is believed at the time of the filing of this patent application to possibly reside broadly in the surface milling cutter, wherein each of said three finishing lips extends along a curvature.

All of the references and documents, cited in any of the documents cited herein, are hereby incorporated by reference as if set forth in their entirety herein. All of the documents cited herein, referred to in the immediately preceding sentence, include all of the patents, patent applications and publications cited anywhere in the present application.

Yet another feature or aspect of an embodiment is believed at the time of the filing of this patent application to possibly reside broadly in the surface milling cutter, including at least one of (A), (B), (C), (D), and (E), wherein (A), (B), (C), (D), and (E) comprise the following: (A) the curvature is a circular curve with a radius, which lies in the range between 500 millimeters and 3000 millimeters; (B) the lead angle is between 40° and 55°; (C) said cutting insert is designed as a double-sided indexable insert; (D) each of said three roughing lips and each of said three finishing lips comprising opposing portions connected in each case over a front face having two partial front faces arranged at a clearance angle and inwardly inclined towards one another; (E) said tool carrying body having an insert seat with at least two front-face bearing faces, and a holding pocket forming a clearance being provided between said bearing faces.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

A further feature or aspect of an embodiment is believed at the time of the filing of this patent application to possibly reside broadly in a surface milling cutter cutting insert of a surface milling cutter, which surface milling cutter has a central rotational axis, which surface milling cutter cutting insert is configured to be disposed at a predetermined distance form the central rotational axis of a surface milling cutter, and which surface milling cutter cutting insert is configured to rotate in a planar configuration substantially at a right angle to a rotational axis of a surface milling cutter, said surface milling cutter cutting insert comprising: an n-angle and n-sided base body where n is equal to or greater than six; said surface milling cutter cutting insert further comprising: a first roughing lip being configured to be disposed at a substantial lead angle, less than 90 degrees, to a surface milling cutter rotational axis; said first roughing lip being configured to be disposed to take a substantial deep cut in a workpiece; a first finishing lip configured to be disposed at an angle which, in operation, is substantially parallel to a surface of a deep cut made by said roughing lip; said first finishing lip being configured to finish, during operation, a surface of a workpiece by smoothing a surface of a deep cut made by said first roughing lip; said first finishing lip being disposed to immediately follow said first roughing lip; said first roughing lip and said first finishing lip being disposed immediately adjacent one another; said first roughing lip having a first end and a second end; said first finishing lip having a first end and a second end; said second end of said first roughing lip and said first end of said first finishing lip being disposed adjacent one another; said first roughing lip and said first finishing lip being configured, in operation to, form a first pair of lips; said first roughing lip being configured to be disposed to lead said first finishing lip, in operation, such that, said first roughing lip machines away a deep, rough, cut; said first finishing lip being configured and disposed to immediately follow, in operation, said first roughing lip to finish and smooth a deep rough cut made by said first roughing lip during operation; said first roughing lip and said first finishing lip forming a first apex angle therebetween; said first roughing lip having a first length and said first finishing lip having a length different from said first length; a second finishing lip having a first end and a second end; said second end of said second finishing lip being disposed adjacent said first end of said first roughing lip; said first roughing lip and said second finishing lip being disposed at a second apex angle; said second apex angle being smaller than said first apex angle; a second of said roughing lips and said second of said finishing lips being disposed immediately adjacent one another; said second roughing lip having a first end and a second end; said second finishing lip having a first end and a second end; said second end of said second roughing lip and said first end of said second finishing lip being disposed adjacent one another; said second roughing lip and said second finishing lip forming a second pair of lips, in operation, upon said second pair of lips being positioned in said front milling face for cutting; said second roughing lip being configured to be disposed to lead said second finishing lip, in machining operation, such that, said second roughing lip machines away a deep, rough, cut upon said second pair of lips being positioned in said front milling face for cutting; said second finishing lip, being configured to immediately follow, upon said second pair of lips being positioned in said front milling face for cutting, said second roughing lip to finish and smooth a deep rough cut made by said second roughing lip during operation; said second roughing lip and said second finishing lip forming a third apex angle therebetween; said second roughing lip having a second length and said second finishing lip having a length different from said second length; a third finishing lip having a first end and a second end; said second end of said third finishing lip being disposed adjacent said first end of said second roughing lip; said second roughing lip and said third finishing lip being disposed at a fourth apex angle; said fourth apex angle being different from said third apex angle; said third of said roughing lips and said third of said finishing lips being disposed immediately adjacent one another; said third roughing lip having a first end and a second end; said third finishing lip having a first end and a second end; said second end of said third roughing lip and said first end of said third finishing lip being disposed adjacent one another; said third roughing lip and said third finishing lip forming a third pair of lips upon said third pair of lips being positioned in said front milling face for cutting; said third roughing lip being configured to be disposed to lead said third finishing lip, in operation, such that, said third roughing lip machines away a deep, rough, cut; said third finishing lip being configured to immediately follow, in operation, said third roughing lip to finish and smooth a deep rough cut made by said third roughing lip during operation; said third roughing lip and said third finishing lip forming a fifth apex angle therebetween; said third roughing lip having a third length and said third finishing lip having a length different from said third length; said first, second, and third roughing lips having a same length; said first, second and third finishing lips having a same length, shorter than the length said first, second, and third roughing lips; said third finishing lip having a first end and a second end; said second end of said first finishing lip being disposed adjacent said first end of said third roughing lip; said first end of said third roughing lip being disposed adjacent said second end of said first finishing lip; said third roughing lip and said first finishing lip forming a sixth apex angle; said sixth apex angle being different from said fifth apex angle; said first apex angle, said third apex angle and said fifth apex angle being equal, and greater than said second apex angle, said fourth apex angle, and said sixth apex angle; said second apex angle, said fourth apex angle, and said sixth apex angle being equal; and each said apex angle being measured through the material of said insert and being less than 180 degrees and greater than 90 degrees.

The details in the patents, patent applications and publications may be considered to be incorporable, at applicant's option, into the claims during prosecution as further limitations in the claims to patentably distinguish any amended claims from any applied prior art.

Another feature or aspect of an embodiment is believed at the time of the filing of this patent application to possibly reside broadly in the surface milling cutter cutting insert, wherein each of said first apex angle, said third apex angle, and said fifth apex angle is at least 5° larger than the nth part of the angular sum of the n-angled base body.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

Yet another feature or aspect of an embodiment is believed at the time of the filing of this patent application to possibly reside broadly in the surface milling cutter cutting insert, wherein the angular sum of the lead angle and of said first apex angle being approximately 180°.

During the machining of a workpiece, in order to achieve a high surface quality of the machined workpiece, an at least hexagonal cutting insert is provided, in which the edges forming the lips 16A and 16B are arranged alternately at a small angle α and a large angle β relatively to one another and are designed alternately as roughing lips 16A and finishing lips 16B. This ensures that a finishing lip 16B, following a roughing lip 16A, of the cutting insert 8 is effective over a greater length.

Still another feature or aspect of an embodiment is believed at the time of the filing of this patent application to possibly reside broadly in the surface milling cutter cutting insert, wherein each of said three finishing lips has a minor-lip clearance to the securing plane.

A further feature or aspect of an embodiment is believed at the time of the filing of this patent application to possibly reside broadly in the surface milling cutter cutting insert, wherein each of said three finishing lips is designed as a wiper lip.

Yet another feature or aspect of an embodiment is believed at the time of the filing of this patent application to possibly reside broadly in the surface milling cutter, including at least one of (A), (B), (C), (D), (E), and (F), wherein (A), (B), (C), (D), (E), and (F) comprise the following: (A) each of said three finishing lips extends along a curvature; (B) the curvature is a circular curve with a radius, which lies in the range between 500 millimeters and 3000 millimeters; (C) said lead angle is between 40° and 55°; (D) said cutting insert is designed as a double-sided indexable insert; (E) each of said three roughing lips and each of said three finishing lips comprising opposing portions connected in each case over a front face having two partial front faces arranged at a clearance angle and inwardly inclined towards one another; and (F) said tool carrying body having an insert seat with at least two front-face bearing faces, and a holding pocket forming a clearance being provided between said bearing faces.

Still another feature or aspect of an embodiment is believed at the time of the filing of this patent application to possibly reside broadly in a surface milling cutter having a central rotational axis, said surface milling cutter comprising: a tool carrying body with a front milling face at one end; at least one surface milling cutter cutting insert disposed at said front milling face, and at a predetermined distance from said central rotational axis; said at least one surface milling cutter cutting insert being disposed to rotate in a planar configuration substantially at a right angle to the rotational axis; said at least one surface milling cutter cutting insert comprising n-angled and n-sided base body where n is equal to or greater than six; each said at least one n-sided surface milling cutter cutting insert comprising n-edges disposed at apex angles, which apex angles are measured through the material of said insert, said apex angles being less than about 180 degrees and greater than about 90 degrees; said at least one surface milling cutter cutting insert comprising: a first roughing lip disposed at a substantial lead angle, to the rotational axis, which first cutting lip is configured and disposed to take a substantial deep cut in a workpiece; said lead angle of said roughing lips being less than 90 degrees; a first finishing lip disposed at an angle which is configured, in operation, to be substantially parallel to a surface of a deep cut made by said roughing lip, which said first finishing lip is configured to finish, during operation, a surface of a workpiece by smoothing a surface of a deep cut made by said first roughing lip; said first roughing lip having a first end and a second end; said first finishing lip having a first end and a second end; said second end of said first roughing lip and said first end of said first finishing lip being disposed adjacent one another; said first roughing lip and said first finishing lip form a first pair of lips; said first roughing lip being configured to be disposed to lead said first finishing lip, in operation, such that said first roughing lip machines away a deep, rough, cut; said first finishing lip being configured and disposed to immediately follow, in operation, said first roughing lip to finish and smooth a deep, rough, cut made by said first roughing lip during operation; said first roughing lip and said first finishing lip forming a first apex angle therebetween; said first roughing lip having a first length and said first finishing lip having a length different from said first length; a second finishing lip having a first end and a second end; said second end of said second finishing lip being disposed adjacent said first end of said first roughing lip; said first roughing lip and said second finishing lip forming a second apex angle therebetween; said second apex angle being smaller than said first apex angle; at least two additional roughing lips and at least one additional finishing lip, one of said at least one additional finishing lip being disposed between two of said at least two additional roughing lips; said roughing lips being of equal length; and said finishing lips being of equal length.

A further feature or aspect of an embodiment is believed at the time of the filing of this patent application to possibly reside broadly in the surface milling cutter, wherein said first apex angle is at least 5° larger than the nth part of the angular sum of the n-angled base body.

Another feature or aspect of an embodiment is believed at the time of the filing of this patent application to possibly reside broadly in the surface milling cutter cutting insert, wherein the angular sum of the lead angle and of said first apex angle being approximately 180°.

Yet another feature or aspect of an embodiment is believed at the time of the filing of this patent application to possibly reside broadly in the surface milling cutter cutting insert, wherein each said finishing lip has a minor-lip clearance to the securing plane.

Still another feature or aspect of an embodiment is believed at the time of the filing of this patent application to possibly reside broadly in the surface milling cutter cutting insert, wherein each said finishing lip is designed as a wiper lip.

A further feature or aspect of an embodiment is believed at the time of the filing of this patent application to possibly reside broadly in the surface milling cutter, including at least one of (A), (B), (C), (D), (E), and (F), wherein (A), (B), (C), (D), (E), and (F) comprise the following: (A) said first finishing lip extends along a curvature; (B) the curvature is a circular curve with a radius, which lies in the range between 500 millimeters and 3000 millimeters; (C) said lead angle of said first roughing lip is between 40° and 55°; (D) said cutting insert is designed as a double-sided indexable insert; (E) each said roughing lip and each said finishing lip comprising opposing portions connected in each case over a front face having two partial front faces arranged at a clearance angle and inwardly inclined towards one another; and (F) said tool carrying body having an insert seat with at least two front-face bearing faces, and a holding pocket forming a clearance being provided between said bearing faces.

Another feature or aspect of an embodiment is believed at the time of the filing of this patent application to possibly reside broadly in a method of machining a plane of a workpiece with a surface milling cutter cutting insert for machining a workpiece with an n-angled base body with n≧6, all n angles being less than 180°, whose n edges defining the n-angled base are alternately designed as finishing lips for finish-machining and as roughing lips for rough-machining of the workpiece, wherein each lip is arranged relative to its adjacent lips at different angles, so that the lips are alternately of different lengths, adjacent lips are arranged alternately at a large angle and a small angle relative to one another and the large angle being maximally 140°; said n edges lie in one plane; said large angle is at least 5° larger than the nth part of the angular sum of the n-angled base body; said roughing lip is arranged in a mounting position in a tool carrying body in an orientation at a defined lead angle to a machining plane, the angular sum of the lead angle and of the large angle being approximately 180°; said finishing lip has a minor-lip clearance to the securing plane; said finishing lip is designed as a wiper lip; said finishing lip extends along a curvature; said curvature is a circular curve with a radius, which lies in the range between 500 millimeters and 3000 millimeters; said cutting insert is provided for lead angles between 40° and 55°, in one embodiment example for a lead angle of 45°; said cutting insert is designed as a double-sided indexable insert with 2n lips; said opposing lips are connected in each case over a front face having two partial front faces arranged at a clearance angle and inwardly inclined towards one another; said cutting insert in combination with a tool for machining a workpiece, such as a milling cutter, with a tool carrying body, on which at least one cutting insert is secured; said tool carrying body has an insert seat with at least two front-face bearing faces, a holding pocket forming a clearance being provided between the bearing faces; said method comprising: at least one cutting insert, one of said roughing lips being oriented to a machining plane of the workpiece at a defined lead angle and engaging the workpiece during a feed motion of the tool, said finishing lip adjacent to said roughing lip simultaneously engaging the workpiece.

The abstract of the disclosure is submitted herewith as required by 37 C.F.R. §1.72(b). As stated in 37 C.F.R. §1.72(b):
A brief abstract of the technical disclosure in the specification must commence on a separate sheet, preferably following the claims, under the heading “Abstract of the Disclosure.” The purpose of the abstract is to enable the Patent and Trademark Office and the public generally to determine quickly from a cursory inspection the nature and gist of the technical disclosure. The abstract shall not be used for interpreting the scope of the claims.

Therefore, any statements made relating to the abstract are not intended to limit the claims in any manner and should not be interpreted as limiting the claims in any manner.

The embodiments of the invention described herein above in the context of the preferred embodiments are not to be taken as limiting the embodiments of the invention to all of the provided details thereof, since modifications and variations thereof may be made without departing from the spirit and scope of the embodiments of the invention.

What is claimed is:

1. A surface milling cutter having a central rotational axis, said surface milling cutter comprising:
a tool carrying body with a front milling face at one end;
a plurality of surface milling cutter cutting inserts disposed about the periphery of said front milling face;
said surface milling cutter cutting inserts being disposed to rotate in a planar configuration substantially at a right angle to the rotational axis;
said surface milling cutter cutting inserts comprising n-angled and n-sided base bodies where n is equal to six;
each said n-sided surface milling cutter cutting insert comprising n-edges disposed at apex angles, which apex angles are measured through the material of said insert, said apex angles being less than 180 degrees and greater than 90 degrees;
said inserts each comprising:
three roughing lips;
said three roughing lips comprising a first roughing lip;
said first roughing lip being disposed at a substantial lead angle, to the rotational axis which said first roughing lip is disposed to take a substantial deep cut in a workpiece, in operation;
said lead angle of said first roughing lip being less than 90 degrees;
three finishing lips;
said three finishing lips comprising a first finishing lip;
said first finishing lip being disposed substantially parallel to a surface of a deep cut made by said first roughing lip;
said first finishing lip being configured to finish, during operation, a surface of a workpiece by smoothing the surface of the deep cut made by said first roughing lip;
each of said three finishing lips being disposed immediately after its corresponding roughing lip, in operation, to finish and smooth the deep rough cut made by each of said three roughing lips;
said first roughing lip having a first end and a second end;
said first finishing lip having a first end and a second end;
said second end of said first roughing lip and said first end of said first finishing lip being disposed adjacent one another;
said first roughing lip and said first finishing lip forming a first pair of lips in operation;
said first roughing lip being configured and disposed to lead said first finishing lip, in operation, such that, said first roughing lip machines away a deep, rough, cut;
said first finishing lip, being configured and disposed to immediately follow, in operation, said first roughing lip to finish and smooth a deep rough cut made by said first roughing lip during operation;
said first roughing lip and said first finishing lip forming a first apex angle therebetween;
said first roughing lip having a first length and said first finishing lip having a length different from said first length;
a second finishing lip having a first end and a second end;
said second end of said second finishing lip being disposed adjacent said first end of said first roughing lip;
said first roughing lip and said second finishing lip being disposed at a second apex angle;
said second apex angle being different from said first apex angle;
said three roughing lips comprising a second roughing lip;
said three finishing lips comprising a second finishing lip;
said second roughing lips and said second finishing lip being disposed immediately adjacent one another;
said second roughing lip having a first end and a second end;
said second finishing lip having a first end and a second end;
said second end of said second roughing lip and said first end of said second finishing lip being disposed adjacent one another;
said second roughing lip and said second finishing lip forming a second pair of lips, in operation, upon said second pair of lips being positioned in said front milling face for cutting;
said second roughing lip being configured to be disposed to lead said second finishing lip, in operation, such that, said second roughing lip machines away a deep, rough, cut upon said second pair of lips being positioned in said front milling face for cutting;
said second finishing lip, being configured to immediately follow, upon said second pair of lips being positioned in said front milling face for cutting, said second roughing lip to finish and smooth a deep rough cut made by said second roughing lip during operation;
said second roughing lip and said second finishing lip forming a third apex angle therebetween;
said second roughing lip having a second length and said second finishing lip having a length different from said second length;
said three finishing lips comprising a third finishing lip;
said third finishing lip having a first end and a second end;
said second end of said third finishing lip being disposed adjacent said first end of said second roughing lip;
said second roughing lip and said third finishing lip being disposed at a fourth apex angle;
said fourth apex angle being different from said third apex angle;
said three roughing lips comprising a third roughing lip;
said third roughing lip and said third finishing lip being disposed immediately adjacent one another;
said third roughing lip having a first end and a second end;
said third finishing lip having a first end and a second end;
said second end of said third roughing lip and said first end of said third finishing lip being disposed adjacent one another;
said third roughing lip and said third finishing lip forming a third pair of lips upon said third pair of lips being positioned in said front milling face for cutting;
said third roughing lip being configured to be disposed to lead said third finishing lip, in operation, such that, said third roughing lip machines away a deep, rough, cut;
said third finishing lip being configured to immediately follow, in operation, said third roughing lip to finish and smooth a deep rough cut made by said third roughing lip during operation;
said third roughing lip and said third finishing lip forming a fifth apex angle therebetween;
said third roughing lip having a third length and said third finishing lip having a length different from said third length;
said first, second, and third roughing lips having a same length;
said first, second and third finishing lips having a same length;
said first, second and third roughing lips having a length different from said first, second and third finishing lips;
said third finishing lip having a first end and a second end;
said second end of said first finishing lip being disposed adjacent said first end of said third roughing lip;
said first end of said third roughing lip being disposed adjacent said second end of said first finishing lip;
said third roughing lip and said first finishing lip forming a sixth apex angle;
said sixth apex angle being different from said fifth apex angle;
said first apex angle, said third apex angle and said fifth apex angle being equal, and greater than said second apex angle, said fourth apex angle, and said sixth apex angle; and
said second apex angle, said fourth apex angle, and said sixth apex angle being equal.

2. The surface milling cutter according to claim 1, wherein each of said first apex angle, said third apex angle, and said fifth apex angle is at least 5° larger than the nth part of the angular sum of the n-angled base body.

3. The surface milling cutter according to claim 2, wherein the angular sum of the lead angle and of said first apex angle being approximately 180°.

4. The surface milling cutter according to claim 3, wherein said first finishing lip has a minor-lip clearance to the securing plane.

5. The surface milling cutter according to claim 4, wherein each of said three finishing lips is designed as a wiper lip.

6. The surface milling cutter according to claim 5, wherein each of said three finishing lips extends along a curvature.

7. The surface milling cutter according to claim 6, including at least one of (A), (B), (C), (D), and (E), wherein (A), (B), (C), (D), and (E) comprise the following:
(A) the curvature is a circular curve with a radius, which lies in the range between 500 millimeters and 3000 millimeters;
(B) the lead angle is between 40° and 55°;
(C) said cutting insert is designed as a double-sided indexable insert;
(D) each of said three roughing lips and each of said three finishing lips comprising opposing portions connected in each case over a front face having two partial front faces arranged at a clearance angle and inwardly inclined towards one another;
(E) said tool carrying body having an insert seat with at least two front-face bearing faces, and a holding pocket forming a clearance being provided between said bearing faces.

8. A surface milling cutter cutting insert of a surface milling cutter, which surface milling cutter has a central rotational axis, which surface milling cutter cutting insert is configured to be disposed at a predetermined distance form the central rotational axis of a surface milling cutter, and which surface milling cutter cutting insert is configured to rotate in a planar configuration substantially at a right angle to a rotational axis of a surface milling cutter,
said surface milling cutter cutting insert comprising:
an n-angle and n-sided base body where n is equal to or greater than six;
said surface milling cutter cutting insert further comprising:
a first roughing lip being configured to be disposed at a substantial lead angle, less than 90 degrees, to a surface milling cutter rotational axis;
said first roughing lip being configured to be disposed to take a substantial deep cut in a workpiece;
a first finishing lip configured to be disposed at an angle which, in operation, is substantially parallel to a surface of a deep cut made by said roughing lip;
said first finishing lip being configured to finish, during operation, a surface of a workpiece by smoothing a surface of a deep cut made by said first roughing lip;
said first finishing lip being disposed to immediately follow said first roughing lip;
said first roughing lip and said first finishing lip being disposed immediately adjacent one another;
said first roughing lip having a first end and a second end;
said first finishing lip having a first end and a second end;
said second end of said first roughing lip and said first end of said first finishing lip being disposed adjacent one another;
said first roughing lip and said first finishing lip being configured, in operation to, form a first pair of lips;
said first roughing lip being configured to be disposed to lead said first finishing lip, in operation, such that, said first roughing lip machines away a deep, rough, cut;
said first finishing lip being configured and disposed to immediately follow, in operation, said first roughing lip to finish and smooth a deep rough cut made by said first roughing lip during operation;
said first roughing lip and said first finishing lip forming a first apex angle therebetween;
said first roughing lip having a first length and said first finishing lip having a length different from said first length;
a second finishing lip having a first end and a second end;
said second end of said second finishing lip being disposed adjacent said first end of said first roughing lip;
said first roughing lip and said second finishing lip being disposed at a second apex angle;
said second apex angle being smaller than said first apex angle;
a second of said roughing lips and said second of said finishing lips being disposed immediately adjacent one another;
said second roughing lip having a first end and a second end;
said second finishing lip having a first end and a second end;
said second end of said second roughing lip and said first end of said second finishing lip being disposed adjacent one another;
said second roughing lip and said second finishing lip forming a second pair of lips, in operation, upon said second pair of lips being positioned in said front milling face for cutting;
said second roughing lip being configured to be disposed to lead said second finishing lip, in machining operation, such that, said second roughing lip machines away a deep, rough, cut upon said second pair of lips being positioned in said front milling face for cutting;
said second finishing lip, being configured to immediately follow, upon said second pair of lips being positioned in said front milling face for cutting, said second roughing lip to finish and smooth a deep rough cut made by said second roughing lip during operation;
said second roughing lip and said second finishing lip forming a third apex angle therebetween;
said second roughing lip having a second length and said second finishing lip having a length different from said second length;
a third finishing lip having a first end and a second end;
said second end of said third finishing lip being disposed adjacent said first end of said second roughing lip;
said second roughing lip and said third finishing lip being disposed at a fourth apex angle;
said fourth apex angle being different from said third apex angle;
said third of said roughing lips and said third of said finishing lips being disposed immediately adjacent one another;
said third roughing lip having a first end and a second end;
said third finishing lip having a first end and a second end;
said second end of said third roughing lip and said first end of said third finishing lip being disposed adjacent one another;
said third roughing lip and said third finishing lip forming a third pair of lips upon said third pair of lips being positioned in said front milling face for cutting;
said third roughing lip being configured to be disposed to lead said third finishing lip, in operation, such that, said third roughing lip machines away a deep, rough, cut;
said third finishing lip being configured to immediately follow, in operation, said third roughing lip to finish and smooth a deep rough cut made by said third roughing lip during operation;
said third roughing lip and said third finishing lip forming a fifth apex angle therebetween;
said third roughing lip having a third length and said third finishing lip having a length different from said third length;
said first, second, and third roughing lips having a same length;
said first, second and third finishing lips having a same length, shorter than the length said first, second, and third roughing lips;
said third finishing lip having a first end and a second end;
said second end of said first finishing lip being disposed adjacent said first end of said third roughing lip;
said first end of said third roughing lip being disposed adjacent said second end of said first finishing lip;
said third roughing lip and said first finishing lip forming a sixth apex angle;
said sixth apex angle being different from said fifth apex angle;
said first apex angle, said third apex angle and said fifth apex angle being equal, and greater than said second apex angle, said fourth apex angle, and said sixth apex angle;
said second apex angle, said fourth apex angle, and said sixth apex angle being equal; and
each said apex angle being measured through the material of said insert and being less than 180 degrees and greater than 90 degrees.

9. The surface milling cutter cutting insert according to claim 8, wherein each of said first apex angle, said third apex angle, and said fifth apex angle is at least 5° larger than the nth part of the angular sum of the n-angled base body.

10. The surface milling cutter cutting insert according to claim 9, wherein the angular sum of the lead angle and of said first apex angle being approximately 180°.

11. The surface milling cutter cutting insert according to claim 10, wherein each of said three finishing lips has a minor-lip clearance to the securing plane.

12. The surface milling cutter cutting insert according to claim 11, wherein each of said three finishing lips is designed as a wiper lip.

13. The surface milling cutter according to claim 12, including at least one of (A), (B), (C), (D), (E), and (F), wherein (A), (B), (C), (D), (E), and (F) comprise the following:
(A) each of said three finishing lips extends along a curvature;
(B) the curvature is a circular curve with a radius, which lies in the range between 500 millimeters and 3000 millimeters;
(C) said lead angle is between 40° and 55°;
(D) said cutting insert is designed as a double-sided indexable insert;
(E) each of said three roughing lips and each of said three finishing lips comprising opposing portions connected in each case over a front face having two partial front faces arranged at a clearance angle and inwardly inclined towards one another; and
(F) said tool carrying body having an insert seat with at least two front-face bearing faces, and a holding pocket forming a clearance being provided between said bearing faces.

14. A surface milling cutter having a central rotational axis, said surface milling cutter comprising:
a tool carrying body with a front milling face at one end;
at least one surface milling cutter cutting insert disposed at said front milling face, and at a predetermined distance from said central rotational axis;
said at least one surface milling cutter cutting insert being disposed to rotate in a planar configuration substantially at a right angle to the rotational axis;
said at least one surface milling cutter cutting insert comprising n-angled and n-sided base body where n is equal to or greater than six;
each said at least one n-sided surface milling cutter cutting insert comprising n-edges disposed at apex angles, which apex angles are measured through the material of said insert, said apex angles being less than about 180 degrees and greater than about 90 degrees;
said at least one surface milling cutter cutting insert comprising:
a first roughing lip disposed at a substantial lead angle, to the rotational axis, which first cutting lip is configured and disposed to take a substantial deep cut in a workpiece;
said lead angle of said roughing lips being less than 90 degrees;
a first finishing lip disposed at an angle which is configured, in operation, to be substantially parallel to a surface of a deep cut made by said roughing lip, which said first finishing lip is configured to finish, during operation, a surface of a workpiece by smoothing a surface of a deep cut made by said first roughing lip;
said first roughing lip having a first end and a second end;
said first finishing lip having a first end and a second end;
said second end of said first roughing lip and said first end of said first finishing lip being disposed adjacent one another;
said first roughing lip and said first finishing lip form a first pair of lips;
said first roughing lip being configured to be disposed to lead said first finishing lip, in operation, such that said first roughing lip machines away a deep, rough, cut;
said first finishing lip being configured and disposed to immediately follow, in operation, said first roughing lip to finish and smooth a deep, rough, cut made by said first roughing lip during operation;
said first roughing lip and said first finishing lip forming a first apex angle therebetween;
said first roughing lip having a first length and said first finishing lip having a length different from said first length;
a second finishing lip having a first end and a second end;
said second end of said second finishing lip being disposed adjacent said first end of said first roughing lip;
said first roughing lip and said second finishing lip forming a second apex angle therebetween;
said second apex angle being smaller than said first apex angle;
at least two additional roughing lips and at least one additional finishing lip, one of said at least one additional finishing lip being disposed between two of said at least two additional roughing lips;
said roughing lips being of equal length; and
said finishing lips being of equal length.

15. The surface milling cutter according to claim 14, wherein said first apex angle is at least 5° larger than the nth part of the angular sum of the n-angled base body.

16. The surface milling cutter cutting insert according to claim 15, wherein the angular sum of the lead angle and of said first apex angle being approximately 180°.

17. The surface milling cutter cutting insert according to claim 16, wherein each said finishing lip has a minor-lip clearance to the securing plane.

18. The surface milling cutter cutting insert according to claim 17, wherein each said finishing lip is designed as a wiper lip.

19. The surface milling cutter according to claim 18, including at least one of (A), (B), (C), (D), (E), and (F), wherein (A), (B), (C), (D), (E), and (F) comprise the following:
(A) said first finishing lip extends along a curvature.
(B) the curvature is a circular curve with a radius, which lies in the range between 500 millimeters and 3000 millimeters;
(C) said lead angle of said first roughing lip is between 40° and 55°;
(D) said cutting insert is designed as a double-sided indexable insert;
(E) each said roughing lip and each said finishing lip comprising opposing portions connected in each case over a front face having two partial front faces arranged at a clearance angle and inwardly inclined towards one another; and
(F) said tool carrying body having an insert seat with at least two front-face bearing faces, and a holding pocket forming a clearance being provided between said bearing faces.

20. A method of machining a plane of a workpiece with a surface milling cutter cutting insert for machining a workpiece with an n-angled base body with n≧6, all n angles being less than 180°, whose n edges defining the n-angled base are alternately designed as finishing lips for finish-machining and as roughing lips for rough-machining of the workpiece, wherein each lip is arranged relative to its adjacent lips at different angles, so that the lips are alternately of different lengths, adjacent lips are arranged alternately at a large angle and a small angle relative to one another and the large angle being maximally 140°;
said n edges lie in one plane;
said large angle is at least 5° larger than the nth part of the angular sum of the n-angled base body;
said roughing lip is arranged in a mounting position in a tool carrying body in an orientation at a defined lead angle to a machining plane, the angular sum of the lead angle and of the large angle being approximately 180°;
said finishing lip has a minor-lip clearance to the securing plane;
said finishing lip is designed as a wiper lip;
said finishing lip extends along a curvature;
said curvature is a circular curve with a radius, which lies in the range between 500 millimeters and 3000 millimeters;
said cutting insert is provided for lead angles between 40° and 55°, in one embodiment example for a lead angle of 45°;
said cutting insert is designed as a double-sided indexable insert with 2n lips;
said opposing lips are connected in each case over a front face having two partial front faces arranged at a clearance angle and inwardly inclined towards one another;
said cutting insert in combination with a tool for machining a workpiece, such as a milling cutter, with a tool carrying body, on which at least one cutting insert is secured;
said tool carrying body has an insert seat with at least two front-face bearing faces, a holding pocket forming a clearance being provided between the bearing faces;
said method comprising:
at least one cutting insert, one of said roughing lips being oriented to a machining plane of the workpiece at a defined lead angle and engaging the workpiece during a feed motion of the tool, said finishing lip adjacent to said roughing lip simultaneously engaging the workpiece.
